(19) United States
(12) Patent Application Publication
(10) Pub. No.: US 2023/0223048 A1
(43) Pub. Date: Jul. 13, 2023

(54) RAPID GENERATION OF VISUAL CONTENT FROM AUDIO

(71) Applicant: AugX Labs, Inc., Irvington, NY (US)

(72) Inventors: Jeremy Toeman, Irvington, NY (US); John Thomas White, Charleston, SC (US); Scott Hilton Havird, Marietta, GA (US); Alex Gurzhi, Cupertino, CA (US); Niranjan Salimath, Bangalore (IN)

(21) Appl. No.: 18/093,849

(22) Filed: Jan. 6, 2023

Related U.S. Application Data
(60) Provisional application No. 63/297,418, filed on Jan. 7, 2022.

(51) Int. Cl. G11B 27/031; G10L 25/57; G10L 15/08; G10L 15/04

(52) U.S. Cl. CPC G11B 27/031; G10L 25/57; G10L 15/08; G10L 15/04; G10L 2015/088

(57) ABSTRACT

A video is generated from an audio file by transcribing the audio file into texts and breaking the audio file into one or more segments or shots used as scenes. A media piece is then matched to each shot; the media pieces are properly contextualized based on the text or attributes of the audio associated with the shot, the overall script or theme, an intended audience, or other factors. The resulting video is then created by stitching the media pieces together.

### CROSS REFERENCE TO RELATED APPLICATION(S)

This patent application claims priority to a co-pending U.S. Provisional Patent Application Ser. No. 63/297,418 filed Jan. 7, 2022 entitled “Generating Video from Audio”, the entire contents of which are hereby incorporated by reference.

### TECHNICAL FIELD

This patent application relates to automatic, rapid generation of visual content.

### BACKGROUND

There are many ways to produce video content. FIG. 1 illustrates a typical workflow. In a strategy and preparation stage 102, a concept for the video is developed, a production team is assembled and other preparations are made. This may include identifying market segments and goals, determining budgets and deadlines, and so forth.

Next, a creative phase 104 occurs. This may include identifying the desired core messages, writing a script, and obtaining any necessary permits or approvals.

In pre-production 106, voiceover(s) may be recorded, filming location(s) scouted, actors and other talent are hired, and stock images and other pre-filming assets are identified and procured.

During a production phase 108 actual filming takes place where the video is actually shot. This may involve setting up cameras and lighting, rehearsing and filming scenes, and capturing audio. This results raw footage in the form of daily clips, or cuts of raw footage in real time and so forth.

Post-production 110 is the editing stage, where raw footage is compiled and refined into a final product. This may include cutting and splicing together different takes, adding special effects, stock images and graphics, and adding music and sound effects or even reshooting scenes if time and budget permit.

Distribution 112 occurs after the video is produced. It can be distributed to various platforms such as social media, online video platforms, or television depending on the budget.

Finally, measurement 114 may identify how well the video is doing to engage the intended audience. These tools may help determine whether increased spend is justified to distribute the video more widely, or if it should be cancelled or re-shot.

It can be seen that many different roles and responsibilities are involved in producing a video, and the process will vary greatly depending on the size and scope of the project. It may involve a small team working on a shoestring budget, or a large crew with access to professional equipment and resources. However, regardless of the budget and scope, once post-production is complete, further editing is difficult, or impossible and failure is expensive.

### SUMMARY OF PREFERRED EMBODIMENT(S)

This patent application describes an improved process for producing video and other visual content. Broadly speaking, the process starts with an input audio file. The input audio file may consist of only speech, but it may also be partially or wholly musical, as long as there are at least some words spoken or sung within it.

The input audio file is then be split into several sections we call shots. Breaks between adjacent shots are preferably determined from characteristics of the speech in the input audio file. These breaks may, for example, depend on where natural pauses occur in the spoken or sung words. The breaks may also depend on other attributes such as the timing, cadence or tone of the speaker's voice.

The detected breaks in the input audio serve to define the output visual as a series of scenes.

Words and/or groups of words (phrases) are then extracted for each shot such as via automated transcription, natural language processing, other or word and phrase detection algorithms or services.

The words or phrases extracted for each shot are then matched against a media library which may include media objects such as static images and/or video clips. Matching media objects may be located by searching on the internet (via a web search engine, or social media search, etc.). The matching static images and/or video clips may also be located in a previously curated or private media library. Matching may be driven by labelling the extracted text and media with attributes. Matching may be further enhanced by pattern matching algorithms, machine learning (ML), or artificial intelligence (AI) engines.

Other aspects may track which media objects were matched against which words or phrases, so that for example, a different media object may be selected when the process is run against the same text again.

The resulting set of static images and/or video clips are then assembled in sequence to generate the output video file.

The output video file may then be distributed. This can be for private use, or posted on the internet for public use such as on YouTube, Twitter, TikTok, Facebook, social media, or any place the user might want to share the output video.

The resulting video is rapidly generated, and automatically contextualized. In particular, the matching media may be located by leveraging aspects of the input audio such as its tone, language or dialect choice, cadance and/or the entirety of the theme or script for the project.

This approach to video content generation greatly assists content creators. The resulting videos are relevant, interesting, and possibly even different each time a video is generated, and likely different and distinctive from other videos.

### BRIEF DESCRIPTION OF THE DRAWINGS

Features and advantages of the approaches discussed herein are evident from the text that follows and the accompanying drawings, where:

FIG. 1 is a high level workflow for a prior art video creation process.

FIG. 2 illustrates a rapid video creation workflow according to the teachings herein.

FIG. 3 shows the workflow in more detail.

FIG. 4 is an example architecture that may be used to implement the workflow.

FIG. 5 is an example data model.

### DETAILED DESCRIPTION OF PREFERRED EMBODIMENT(S)

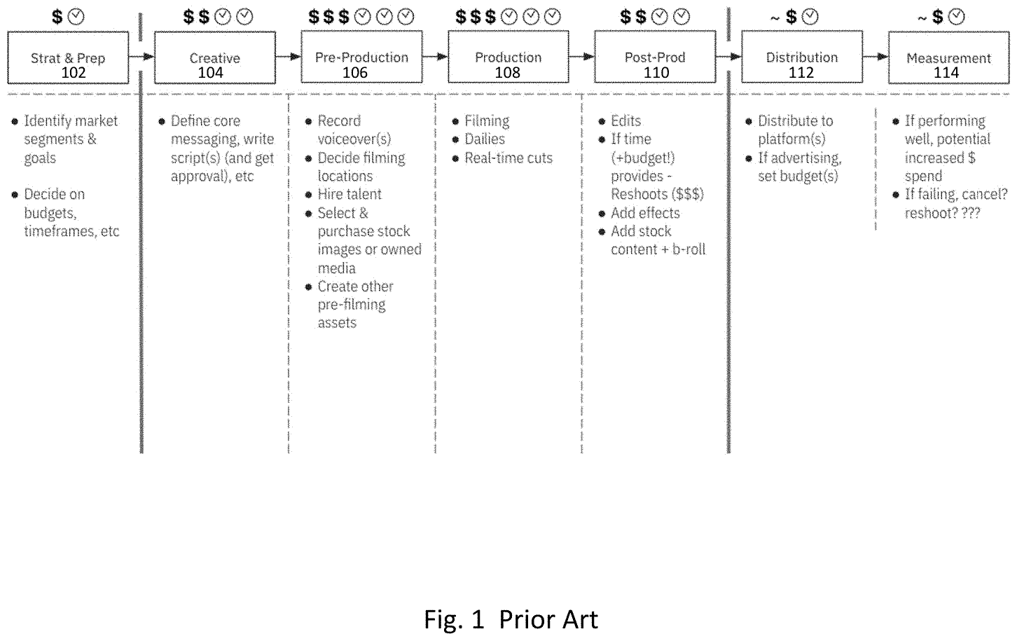

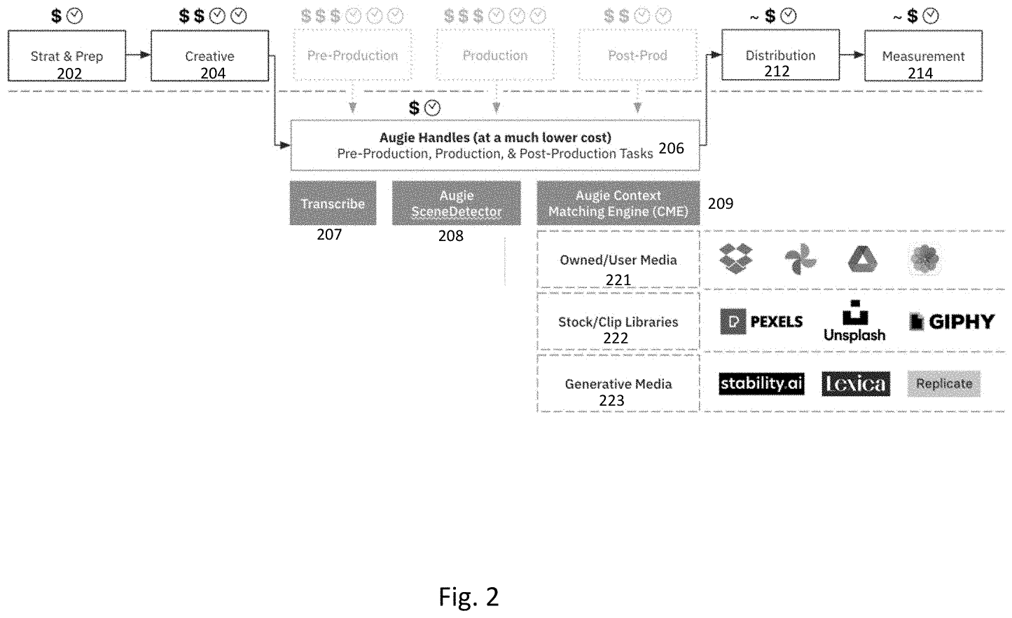

FIG. 2 illustrates a rapid video production process 200 according to one embodiment. The strategy and preparation 202 and creative 204 phases may occur as per the prior art flow of FIG. 1. Similarly, the distribution 212 and measurement 214 phases may also occur as in the prior art.

Here, however, the pre-production, production and post-production phases are replaced with an unified and augmented phase 206 we refer to as “Augie” for short. As will be explained in more detail below, this phase 206 uses video transcription 207, scene detection 208 and a Context Matching Engine (CME) 208 to automatically and rapidly generate an output video from an input audio file.

Briefly, transcription 207 performs speech to text conversion on the input audio file. Scene detection 208 detects breaks in the input audio file to create one or more shots. The CME 208 then matches the text associated with each shot against owned or other user media 221, stock images or clips 222, generative media 223 (e.g., Stability.ai, Lexica.art, or Replicate) or other media sources.

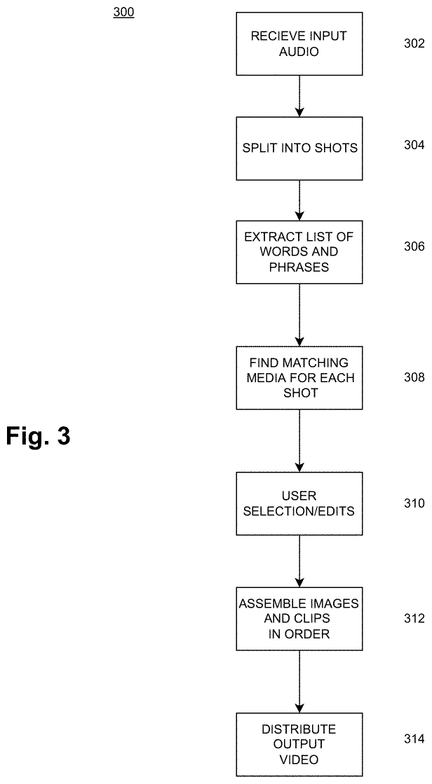

FIG. 3 shows an example workflow 300 in more detail. The workflow 300 starts with a state 302 that identifies an input audio file. The input audio file may consist of only speech, but it may also be partially or wholly musical, as long as there are at least some words spoken or sung within it.

In state 304, the input audio file may then be split into several sections we call shots or slots. Breaks between adjacent shots may be determined by analyzing characteristics of the speech in the input audio file. These breaks may, for example, depend on where natural pauses occur in the spoken or sung words. Other attributes of the input audio file may also be used to determine where to place these breaks such as the timing, cadence, language, dialect, or tone of the speaker's voice. These breaks in the audio are then used to define where each scene in the resulting output video will start and end.

In some cases where a spoken audio file is not available, and the only available input is the text of a script, breaks between adjacent shots may, optionally, be determined by analyzing characteristics of the text and/or the meaning of the text. These breaks may be determined by examining punctuation, sentence structure, sentence length, paragraph breaks, or by using language understanding algorithms to determine where breaks typically occur.

Next, in state 306, a list of words and/or phrases are extracted from each audio slot. The extraction of words and/or groups of words (phrases) from each shot may be via automated transcription, natural language processing, or other word and phrase detection algorithms or services.

Although the splitting state 304 and word extraction 306 states are shown in a specific order, it should be understood that they may be reversed. In other words, word extraction for the entire input file may occur before it is split into shots.

In state 308, media is matched against the extracted words and/or phrases for each shot such as by using the Context Matching Engine (CME) discussed above. The media may include static images and/or video clips. The static images and/or video clips may be matched by searching public sources on the internet (via a web search engine, or social media search, etc.). The static images and/or video clips may also be matched from a previously curated or private media library. They may also be obtained from generative media sources that generate the media based on context, such as the words and/or phrases that were extracted from the audio file.

The media may include many different types of digital containers. In the case of still images, there is a wide range of file formats that can be used, such as JPEG, PNG, GIF, TIFF, RAW, BMP, WMF, PDF etc. The data stored in the container file may be compressed or uncompressed. For some applications, they may be raster or vector formats and image file formats support transparency. In the case of video clips, they may be any type of digital container for a motion picture (GIF, MOV, MP4, WMV, SWF, etc.). The codes, frame rates, aspect ratio, bit rate, resolution, animation/real life, vector or raster format. etc. do not matter.

Matching may be driven by labelling both the extracted text and media with attributes as explained in more detail below. For example, each audio shot may have attributes that depend on the content or characteristics of the audio shot or the overall theme or the script. Each media image or video clip may also be labeled with attributes that depend on its visual content.

The Context Matching Engine then learns how to pick a best visual by matching media attributes with the shot attributes.

Matching may be further enhanced by using these attributes to drive pattern matching algorithms, machine learning (ML), or artificial intelligence (AI) engines.

In an optional state 310, a user may be given a choice to select from one or more media that matched the text in each of one or more shots. The user's choice may further drive the ML or AI engines.

Other aspects may track which images and clips were matched against which words or phrases, so that for example, a different media file may be selected when the matching process is run against the same text again.

The resulting set of static images and/or video clips are then assembled in sequence to generate the output video file in state 312.

The output video file may then be distributed in state 314. This distribution state 314 can be for private use, or posted on the internet for public use such as on YouTube, Twitter, TikTok, Facebook, social media, or any place the user might want to share the output video.

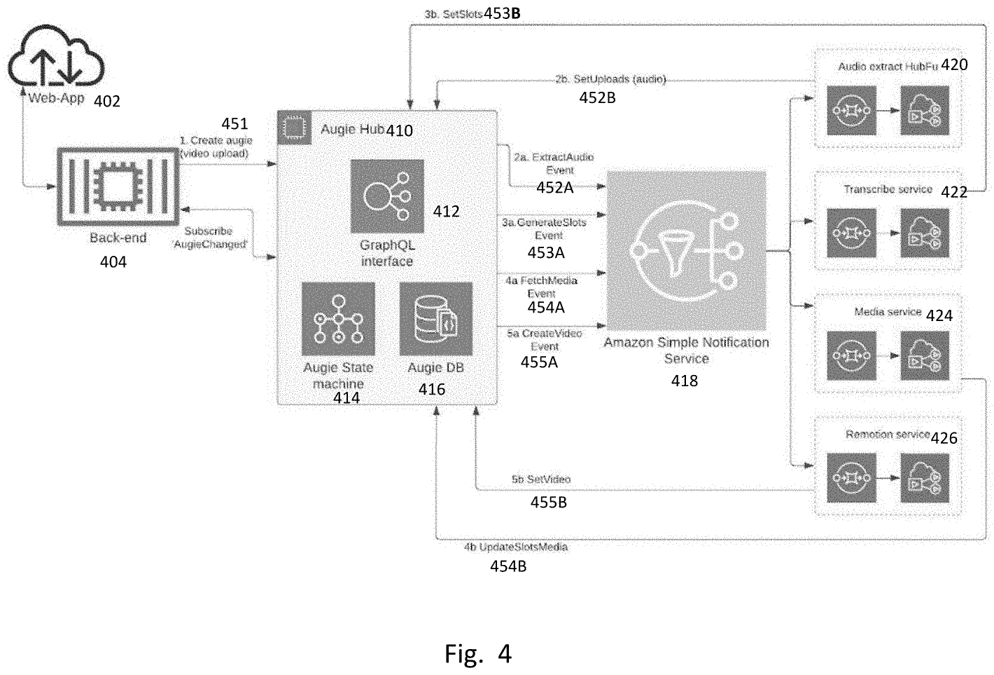

FIG. 4 shows an example architecture of a system 400 that implements the workflow of FIG. 3 using various cloud services. A user interacts with the system 400 via an application 402 such as a web or mobile application. The application 402 in turn interacts with an Augie hub 410 via a back end server 404.

The hub 410 implements the workflow logic. It may be accessed via a query language type Application Programming Interface (API) such as GraphQL 412, implement a state machine 414 and store data in a database 416.

The hub 410 interacts with a notification service 418 such as Amazon Simple Notification Service to access external services. These external services may include an audio extraction service 420, a transcription service 422, a media service 424, and remotion service 426.

The following states are implemented by state machine 414.

In state 451 the user has uploaded an input audio file via the web app 402 through the back end 404 to the hub 410.

In state 452A the state machine 414 sends an extract audio event (“ExtractAudioEvent”) to notification service 418 which in turn invokes audio extraction 420. This results in state 452B (“SetUploads”) where the input audio file is returned as a set of shots.

In state 453A the state machine 414 sends a transcribe audio event (“GenerateShotsEvent”) to notification service 418 which in turn invokes transcription service 422. This results in state 453B (“SetShots”) returning the transcribed text for each shot.

In state 454A the state machine 414 sends a fetch media event (“FetchMediaEvent”) to media service 424 for each shot. Media service implements the Contextual Machine Engine (CME) described herein resulting in state 454B (“UpdateShotsMedia”) which returns one or more media objects.

In state 455A (“CreateVideoEvent”) the state machine 414 sends a create video event to remotion service which in state 455B (“SetVideo”) returns the output video assembled from the media associated with each shot.

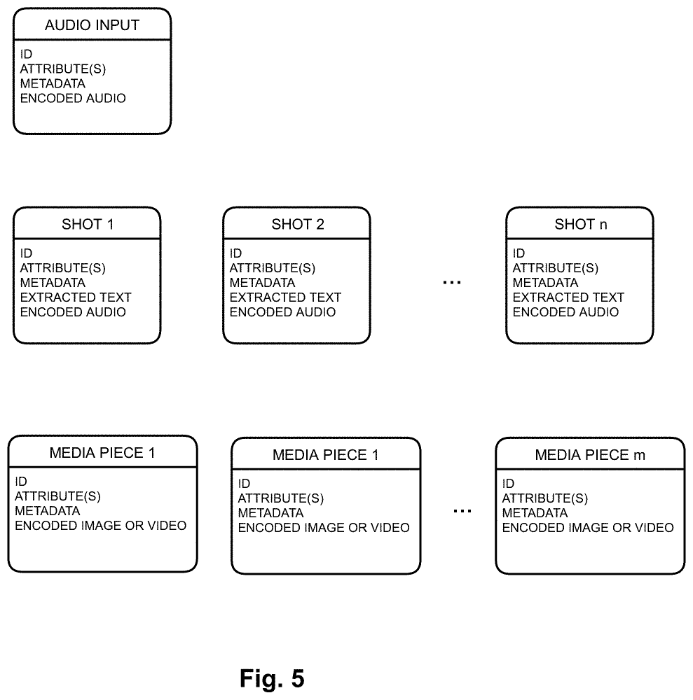

FIG. 5 illustrates example data models that may include objects that represent the input audio files, each of several shots (1 through n), and each of several media pieces (1 through m).

Each of these data objects include fields representing an encoded audio file or media (image or video) file, and at least a unique identifier (ID) and the attributes described above.

The shot objects may include the associated extracted words or phrases that were extracted from the audio data.

Other metadata may include things such as time and date of the input audio file, an owner of a media piece, etc.

### Genre-Based and Context-Based Dictionaries or Lexicons

The Context Matching Engine may match images or video clips based on attributes of the associated input audio shot. These attributes may include its tone, cadence, language, regionalism, dialect, and other features. For example, when an audio shot that discusses coffee is detected as containing a New England regional accent, the matched image may be that of a Dunkin Donuts store, and if it contains a Canadian regional accent, the matching process may retrieve an image of a Tim Hortons.

The content of the matched media may also depend on an intended audience or theme. In other words, the match results may be limited to finding media that would be more targeted towards a particular subject, topic, age group, location, or other particular demographic.

For example, if the audio input file is a child's audio book, then the matching media may be limited to cartoon imagery.

In another example, the audio input file is a true crime podcast, and an example spoken phrase was “total recall” which was spoken in the context of a witness not having a complete memory at the scene of the crime. The matching image for “total recall” may be a picture of a brain, or someone scratching their head, or some other image that implies loss of memory.

However in another example, the input audio file might be movie-related podcast that mentions the movie Total Recall. The phrase Total Recall may match a static image of a movie poster, a clip from the movie, or an image or clip that shows one of the actors from the movie.

The matching selected movie clip might depend on the audience—for example, if the audience is males over the age of 45, the match may be a video clip from the Total Recall movie from the 1980s, whereas if the audience is 20-somethings, the clip would be pulled from the Total Recall movie from the 2000s.

The process may be interactive, with a user being presented with a set of search results for each building block, with an option to select which resulting media piece they prefer.

### Adaptive and/or Themed Video Generation

Machine learning may also be deployed such that as a person creates their content, and their edits are tracked as they remove, replace or change the clips that are being fetched for their consideration. Every time that the user provides feedback through their editing, the process can leverage machine learning or artificial intelligence to adapt to their preferences.

In other aspects, the generated video may be triggered based on both the input audio source and the intended audience. The same audio input file can be dynamically processed to enable different versions to be generated with attributes that depend on the viewer.

For example, a service may host the resulting output video and interpret its content in real time during playback. In this way, the resulting display of a given output video may actually be different depending on the genre-preference, demographics, or other attribute of each viewer. A first viewer who is a 48 year old male would thus see a different Total Recall movie clip than a second viewer who is a 23 year old female.

Matching images and video clips media files may be augmented by leveraging metadata available when the static images and video clips originate from sources such as YouTube or TikTok.

A private media repository can also be enhanced with metadata to enable an improved matching process. For example, a search of “handsome actor” may pull up a clip of The Rock if the audience is 20-somethings, but a static image of Robert Redford if the audience is over-65. A search of “baseball slugger” could retrieve a picture of Hank Aaron for one audience (elderly fan of the Atlanta Braves), but Aaron Judge for another audience (teenage New York Yankees fan).

The automated generation of video may also be event triggered. For example, the publisher of a podcast may link their YouTube account, so that each time a new audio podcast is published to Spotify, a corresponding video file is generated and posted to YouTube.

The process may also leverage access to the user's YouTube credentials in other ways, such as to inform the machine learning tool from the user's YouTube viewing profile/history.

The more data that can be garnered about the audiences (both the creators and the viewers), the more the system can be informed. For example, certain things can be tracked for each output video—who listens to it and for how long?—to also inform the selection of media (with media clips having low viewership ranked lower in the search results).

The resulting video may be capable of realtime deployment such as by replacing a Twitch stream or as a Discord plug-in, in other ways.

### Scaling Pace to the Subject or the Audience

The tempo of the video clips may also be adapted to the audience. If the user is an executive looking to prepare a video to complement a business presentation, she could specify a very limited library of images that do not change, say, more often than once per minute.

On the other hand, if the user is an e-sports athlete and their audience is composed of college students less than 21 years old, the cadence of the generated clips may be rapid (say a new image or clip every few seconds).

The cadence can also be controlled based on who the viewer is. Thus, two different viewers of the same generated dynamic video file may actually see different sets of images and clips that are changed at different paces.

### Advertising Model

Product placement is often a lucrative aspect of advertising. The above described methods of generating a video lends itself to a model where advertisers pay for being ranked in the search to find a matching media. Perhaps the content creator is looking for a match to the phrase “And they down to the pub on Thursday night and had a great time with friends”. Different alcohol brands (Coors, Dewars and Macallan) could provide clips to use in the libraries and compensate for their use. The content creator is thus rewarded for using the advertiser's clips.

### Further Implementation Options

It should be understood that the workflow of the example embodiments described above may be implemented in many different ways. In some instances, the various “data processors” may each be implemented by a physical or virtual or cloud-based general purpose computer having a central processor, memory, disk or other mass storage, communication interface(s), input/output (I/O) device(s), and other peripherals. The general-purpose computer is transformed into the processors and executes the processes described above, for example, by loading software instructions into the processor, and then causing execution of the instructions to carry out the functions described.

As is known in the art, such a computer may contain a system bus, where a bus is a set of hardware lines used for data transfer among the components of a computer or processing system. The bus or busses are essentially shared conduit(s) that connect different elements of the computer system (e.g., one or more central processing units, disks, various memories, input/output ports, network ports, etc.) that enables the transfer of information between the elements. One or more central processor units are attached to the system bus and provide for the execution of computer instructions. Also attached to system bus are typically I/O device interfaces for connecting the disks, memories, and various input and output devices. Network interface(s) allow connections to various other devices attached to a network. One or more memories provide volatile and/or non-volatile storage for computer software instructions and data used to implement an embodiment. Disks or other mass storage provides non-volatile storage for computer software instructions and data used to implement, for example, the various procedures described herein.

Embodiments may therefore typically be implemented in hardware, custom designed semiconductor logic, Application Specific Integrated Circuits (ASICs), Field Programmable Gate Arrays (FPGAs), firmware, software, or any combination thereof.

In certain embodiments, the procedures, devices, and processes described herein are a computer program product, including a computer readable medium (e.g., a removable storage medium such as one or more DVD-ROM's, CD-ROM's, diskettes, tapes, etc.) that provides at least a portion of the software instructions for the system. Such a computer program product can be installed by any suitable software installation procedure, as is well known in the art. In another embodiment, at least a portion of the software instructions may also be downloaded over a cable, communication and/or wireless connection.

Embodiments may also be implemented as instructions stored on a non-transient machine-readable medium, which may be read and executed by one or more procedures. A non-transient machine-readable medium may include any mechanism for storing or transmitting information in a form readable by a machine (e.g., a computing device). For example, a non-transient machine-readable medium may include read only memory (ROM); random access memory (RAM); storage including magnetic disk storage media; optical storage media; flash memory devices; and others.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc.

It also should be understood that the block and system diagrams may include more or fewer elements, be arranged differently, or be represented differently. But it further should be understood that certain implementations may dictate the block and network diagrams and the number of block and network diagrams illustrating the execution of the embodiments be implemented in a particular way.

Embodiments may also leverage cloud data processing services such as Amazon Web Services, Google Cloud Platform, and similar tools.

Accordingly, further embodiments may also be implemented in a variety of computer architectures, physical, virtual, cloud computers, and/or some combination thereof, and thus the computer systems described herein are intended for purposes of illustration only and not as a limitation of the embodiments.

The above description has particularly shown and described example embodiments. However, it will be understood by those skilled in the art that various changes in form and details may be made therein without departing from the legal scope of this patent as encompassed by the appended claims.

1. A method for generating an output video file from an input audio file, the method comprising:
splitting the input audio file into two or more slots;
extracting one or more words from each of the slots;
matching a context of the extracted words against two or more media files to identify one or more associated media files for each shot; and
generating the output video file from the associated media files for each of the shots.

2. The method of claim 1 wherein splitting the input audio file further comprises:
determining one or more places to split the audio input file based on characteristics of the audio file.

3. The method of claim 2 wherein the characteristics of the input audio file comprise pauses, tone or cadence.

4. The method of claim 1 wherein the context of the extracted words depends on an intended audience.

5. The method of claim 3 wherein the context of the extracted words depends on one or more attributes of the input audio file.

6. The method of claim 5 wherein the attributes of the input audio file include cadence, dialect, regionalisms or language.

7. The method of claim 1 wherein the context of the extracted words is provided as an input from a user.

8. The method of claim 1 wherein the associated media files are generative media that is generated based on the context of the extracted words.

9. The method of claim 1 wherein a pace of the output video file is scaled to an intended audience.

10. The method of claim 1 wherein
a user input determines which of the associated media files is selected from two or more associated media files; and
the matching further comprises a machine learning process that utilizes the user input.

11. An apparatus for generating an output video comprising:
one or more data processors; and
one or more computer readable media including instructions that, when executed by the one or more data processors, cause the one or more data processors to perform a process for:
receiving an input audio file;
splitting the input audio file into two or more shots;
extracting one or more words from each of the shots;
matching a context of the extracted words against two or more media files to identify one or more associated media files for each shot; and
generating the output video file from the associated media files for each of the shots.

12. The apparatus of claim 11 wherein splitting the input audio file further comprises:
determining one or more places to split the input audio file based on characteristics of the audio content.

13. The apparatus of claim 12 wherein the characteristics of the input audio file comprise pauses, tone or cadence.

14. The apparatus of claim 11 wherein the context of the extracted words depends on an intended audience.

15. The apparatus of claim 13 wherein the context of the extracted words depends on one or more attributes of the input audio file.

16. The apparatus of claim 15 wherein the attributes of the input audio file include cadence, dialect, regionalisms or language.

17. The apparatus of claim 11 wherein the context of the extracted words is provided as an input from a user.

18. The apparatus of claim 11 wherein the associated media files are generative media that is generated based on the context of the extracted words.

19. The apparatus of claim 11 wherein a pace of the output video file is scaled to an intended audience.

20. The apparatus of claim 11 wherein
a user input determines which of the associated media files is selected from two or more associated media files; and
the matching further comprises a machine learning process that utilizes the user input.
